(19) United States
(12) Patent Application Publication
(10) Pub. No.: US 2011/0271529 A1
(43) Pub. Date: Nov. 10, 2011

(54) ENDODONTIC ROTARY INSTRUMENTS MADE OF SHAPE MEMORY ALLOYS IN THEIR MARTENSITIC STATE AND MANUFACTURING METHODS

(75) Inventors: Yong Gao, Broken Arrow, OK (US); Randall Maxwell, Broken Arrow, OK (US)

(73) Assignee: DENTSPLY International Inc., York, PA (US)

(21) Appl. No.: 13/102,439

(22) Filed: May 6, 2011

Related U.S. Application Data
(60) Provisional application No. 61/332,954, filed on May 10, 2010.

(51) Int. Cl. B23P 17/00

(52) U.S. Cl. 29/896.1

(57) ABSTRACT

A method for manufacturing a non-superelastic rotary file comprising the steps of: providing a superelastic rotary file having an austenite finish temperature; and heating the superelastic rotary file to a temperature of at least about 300° C. for a time period of at least about 5 minutes to alter the austenite finish temperature thereby forming the non-superelastic rotary file; wherein the altered austenite finish temperature of the non-superelastic rotary file is greater than about 25° C.

### FIELD OF INVENTION

The present invention is directed to a method for treating a dental instrument, and specifically to a rotary file useful for shaping and cleaning root canals with severe curvature.

### BACKGROUND OF THE INVENTION

The endodontic instruments (including files and reamers) are used for cleaning and shaping the root canals of infected teeth. They may be in mode of either rotation or reciprocation in the canal by dentists, either manually or with the aid of dental handpieces onto which the instruments are mounted. Instruments are generally used in sequence (depending on different root canal surgery techniques) in order to achieve the desired outcome of cleaning and shaping. The endodontic instrument is subjected to substantial cyclic bending and torsional stresses as it is used in the process of cleaning and shaping a root canal. Because of the complex curvature of root canals, a variety of unwanted procedural accidents such as ledging, transportation, perforation, or instrument separation, can be encountered in the practice of endodontics.

Currently, endodontic rotary instruments made of Shape Memory Alloys (SMA) have shown better overall performance than stainless steel counterparts. However, the occurrence of unwanted procedural accidents mentioned above has not been drastically reduced. Therefore, it necessitates new endodontic instruments with improved overall properties, especially flexibility and resistance to fracture either due to cyclic fatigue and torsional overload.

### SUMMARY OF THE INVENTION

The present invention seeks to improve upon prior endodontic instruments by providing an improved, process for manufacturing endodontic instruments. In one aspect, the present invention provides a method for manufacturing a non-superelastic rotary file comprising the steps of: providing a superelastic rotary file having an austenite finish temperature; and heating the superelastic rotary file to a temperature of at least about 300° C. for a time period of at least about 5 minutes to alter the austenite finish temperature thereby forming the non-superelastic rotary file; wherein the altered austenite finish temperature of the non-superelastic rotary file is greater than about 25° C.

In another aspect, the present invention contemplates a method for manufacturing a non-superelastic rotary file comprising the steps of: providing a non-superelastic wire having an austenite finish temperature greater than about 25° C.; heating the non-superelastic wire to a manufacturing temperature that is higher that the austenite finish temperature; and forming flutes, grooves, or a combination of both about the superelastic wire to form a rotary file; wherein the rotary file is non-superelastic at a temperature that ranges from about 25° C. to about the austenite finish temperature

In yet another aspect, any of the aspects of the present invention may be further characterized by one or any combination of the following features: the austenite finish temperature of the non-superelastic rotary file is greater than 27° C.; the altered austenite finish temperature of the non-superelastic rotary file is greater than 30° C.; the altered austenite finish temperature of the non-superelastic rotary file is greater than 37° C.; the heating step, the temperature ranges from about 300° C. to about 600° C.; the heating step, the heating step, the manufacturing temperature ranges from about 5° C. to about 200° C.; the time period ranges from about 5 minutes and about 120 minutes; the superelastic rotary file includes a shape memory alloy; the shape memory alloy includes nickel and titanium; the shape memory alloy includes a copper based alloy, an iron based alloy or a combination of both; the shape memory alloy is a nickel-titanium based ternary alloy; the nickel-titanium based ternary alloy of the formula Ni—Ti—X wherein X is Co, Cr, Fe, or Nb; a ratio of peak torque of the non-superelastic rotary file to the superelastic rotary file is less than about 8:9 at about 25° C.; a ratio of total number of cycles to fatigue of the non-superelastic rotary file to the superelastic rotary file is at least about 1.25:1 at about 25° C.; or any combination thereof.

It should be appreciated that the above referenced aspects and examples are non-limiting as others exist with the present invention, as shown and described herein. For example, any of the above mentioned aspects or features of the invention may be combined to form other unique configurations, as described herein, demonstrated in the drawings, or otherwise.

### BRIEF DESCRIPTION OF THE DRAWINGS

FIG. 1 is an elevational view of a typical endodontic instrument.

FIG. 2 is an elevational cross-sectional view of a molar human tooth showing the root system and the coronal area penetrated by a hole to expose the root canal system.

FIG. 3 is a Differential Scanning calorimetry (DSC) curve showing phase transformation temperatures of the present invention.

FIG. 4 is a diagrammatic representation of a bending test apparatus to measure stiffness or root canal instruments as described in ISO 3630-1:2008, Dentistry—Root-canal instrument—Part I: General requirements and test methods).

FIG. 5 is a chart showing the testing results of the test method shown in FIG. 4.

FIG. 6 is diagrammatic representation of a test apparatus used to test the bending-rotation fatigue resistance of endodontic instruments.

FIG. 7 is a schematic graph of the relationship between different NiTi microstructures (austenic vs. martensitic) and average cyclic fatigue life of endodontic rotary instruments made of NiTi shape memory alloy.

FIG. 8 is a diagrammatic representation of a torque test apparatus used to measure the resistance to fracture by twisting and angular deflection as described in ISO 3630-1:2008, Dentistry—Root-canal instrument—Part I: General requirements and test methods).

FIG. 9 is a schematic graph of the relationship between different metallurgical structures and average “maximum degree of rotation to fracture” of endodontic rotary instruments made of NiTi shape memory alloy.

FIG. 10 is a schematic graph of the relationship between different metallurgical structures and average “peak torque” of endodontic rotary instruments made of NiTi shape memory alloy.

FIG. 11 shows a root with a highly curved canal and a complex canal shape.

### DETAILED DESCRIPTION OF INVENTION

Superelastic materials are typically metal alloys which return to their original shape after substantial deformation. Examples of efforts in the art towards superelastic materials are found in U.S. Pat. No. 6,149,501, which is herein incorporated by reference for all purposes.

The endodontic rotary instrument made of shape memory alloys (e.g., NiTi based, Cu based, Fe based, or combinations thereof) in their martensitic state of the present invention may provide more flexibility and increase fatigue resistance by optimized microstructure, which is particularly effective in shaping and cleaning canals with severe curvatures. Superelastic alloys such as nickel titanium (NiTi) or otherwise can withstand several times more strain than conventional materials, such as stainless steel, without becoming plastically deformed.

This invention relates to dental instruments in general. Specifically, this invention relates to endodontic rotary instruments for use in root canal cleaning and shaping procedures. The present invention provides an innovation of endodontic instrument that is made of shape memory alloys (SMA) such as Nickel-Titanium (NiTi) based systems, Cu based systems Fe based systems, or any combination thereof (e.g., materials selected from a group consisting of near-equiatomic Ni—Ti, Ni—Ti—Nb alloys, Ni—Ti—Fe alloys, Ni—Ti—Cu alloys, beta-phase titanium and combinations thereof).

The present invention comprises rotary instruments made of NiTi Shape Memory Alloys, which provide one or more of the following novel aspects:

Primary metallurgical phase in microstructure: martensite is the primary metallurgical phase in the present invention instrument, which is different from standard NiTi rotary instruments with predominant austenite structure at ambient temperature;

Higher austenite finish temperature (the final A.sub.f temperature measured by Differential Scanning calorimetry): the austenite finish temperature is preferably higher (e.g., at least about 3° C.) than the ambient temperature (25° C.); in contrast, most standard superelastic NiTi rotary instruments have austenite finish temperatures lower than ambient temperature;

Due to higher austenite finish temperature, the present invention instrument would not return to the original complete straight state after being bent or deflected; in contrast, most standard superelastic NiTi rotary instruments can return to the original straight form via reverse phase transformation (martensite-to-austenite) upon unloading.

Endodontic instruments made of NiTi shape memory alloys in their martensitic state have significantly improved overall performance than their austenitic counterparts (regular superelastic NiTi instruments), especially on flexibility and resistance against cyclic fatigue.

The strength and cutting efficiency of endodontic instruments can also be improved by using ternary shape memory alloys NiTiX (X: Co, Cr, Fe, Nb, etc) based on the mechanism of alloy strengthening.

Specifically, the present invention instrument has essential and most desired characteristics for successful root canal surgery, including higher flexibility and lower stiffness, improved resistance to cyclic fatigue, higher degree of rotation against torsional fracture, more conforming to the shape of highly curved canals (less likely for ledging or perforation), and minimum possibility of instrument separation in comparison against conventional endodontic instruments made of NiTi shape memory alloy in superelastic condition with fully austenitic phase in microstructure.

### Methods of Manufacturing Martensitic Endodontic Instruments

In one embodiment of the present invention, endodontic instruments made of NiTi shape memory alloys in their martensitic state may be fabricated by the following method:

Method 1: Post heat treatment after the flutes of a file have been manufactured according to mechanical design (i.e., after the flute grinding process in a typical file manufacturing process).

This method may include a post heat treatment having a heating step at temperature of at least 300° C. Preferably the heating step includes a temperature ranging from about 300° C. to about 600° C., and more preferably from about 370° C. to about 510° C. The heat treatment step may be present for a time period of at least 5 minutes. Preferably, the heating step may be present for a time period that ranges from about 5 minutes to about 120 minutes, and more preferably from about 10 minutes to about 60 minutes (typically under a controlled atmosphere).

For example, the additional thermal process of Method 1 may be employed in after the traditional NiTi rotary file manufacturing process (e.g., grinding of the flutes) using regular superelastic NiTi wires. More particularly, an additional thermal process may be performed after the flute grinding process (of a traditional NiTi rotary file manufacturing process) so that a post heat treatment occurs at a temperature range of 370˜510° C. for a period of time (typically 10˜60 min, depending on file size, taper, and/or file design requirement). It is appreciated that Nickel-rich precipitates may form during this post heat treatment process. Correspondingly, the ratio of Ti/Ni may increase and a desired austenite finish temperature (the final A_{f} temperature) will be achieved. After post heat treatment, a file handle (e.g., brass, steel, the like, or otherwise may be installed.

In another embodiment of the present invention, endodontic instruments made of NiTi shape memory alloys in their martensitic state may be fabricated by the following method:

Method 2: Heat treatment during the manufacturing process of the file (e.g., during the grinding process) to ensure the temperature on the NiTi materials is higher than their austenite finish temperatures:

This method may include (concurrent) heat treatment to wires prior to and/or during the grinding process so that grinding will be directly applied to martensitic SMA (e.g., NiTi) wires. However, it is appreciated that martensitic SMA (e.g., NiTi) wires may be heated to a temperature higher than their austenite finish temperatures during grinding process. Therefore, martensitic SMA (e.g., NiTi) wires may temporarily transform to superelastic wires (a stiffer structure in the austenitic state) to facilitate the grinding process during the instrument manufacturing process. Advantageously, the instruments will transform back to martensitic state at ambient temperature after the flute grinding process.

For example, in one embodiment, Method 2 may include a non-superelastic wire. The non-superelastic wire may be provided in a manufacturing environment with a temperature higher than its austenite finish temperature (at least 25 degree C.). The non-superelastic wire may transform to superelastic at this higher temperature). Then forming flutes and grooves about the file to form the (semi finished) rotary file. Furthermore, the (semi-finished) rotary file may be removed from the manufacturing environment with higher (warmer) temperature. The non-superelastic wire may form a non-superelastic rotary file at (or above) room temperature about 25° C.

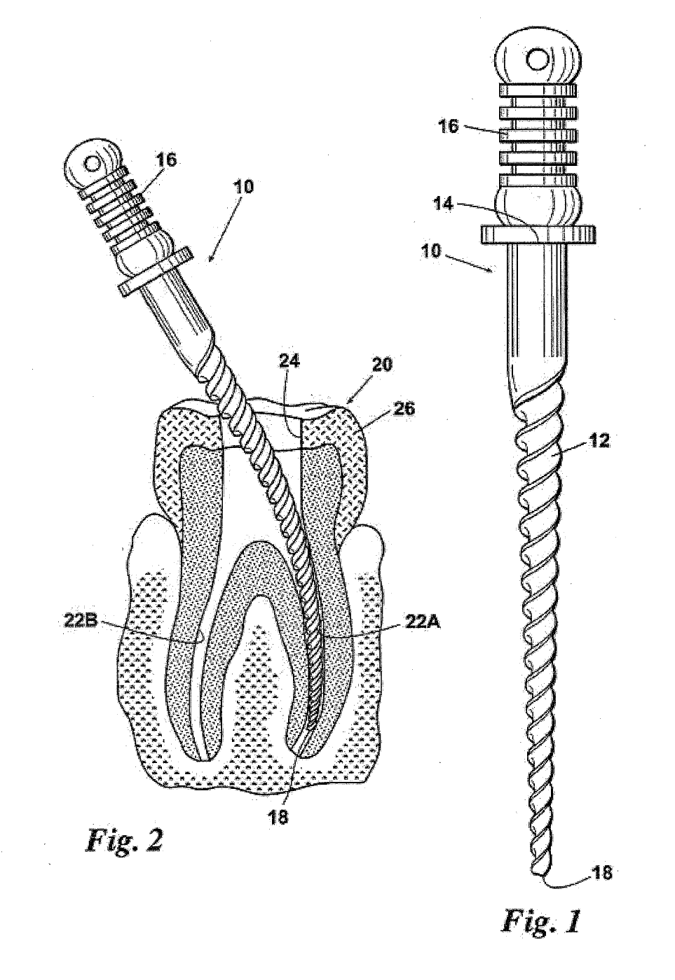

With respect to FIGS. 1 and 2, an endodontic instrument is shown positioned within one of the root canals is the endodontic instrument. While in this position, the endodontic instrument is typically subjected to substantial cyclic bending and torsional stresses as it is used in the process of cleaning and shaping a root canal.

It is believed that a shape memory alloy like NiTi alloy generally has two primary crystallographic structures, which are temperature dependent, (i.e. austenite at higher temperatures and martensite at lower temperatures). This temperature-dependent diffusionless phase transformation will be from martensite (M) to austenite (A) (e.g., M→A) during heating. Furthermore, it is appreciated that a reverse transformation from austenite to martensite (A→M) may be initiated upon cooling. In another embodiment, an intermediate phase (R) may appear during phase transformations i.e., either (M)→(R)→(A) during heating or (A)→(R)→(M) during cooling. The R-phase being defined as an intermediate phase between the austenite phase (A) and the martensite phase (M).

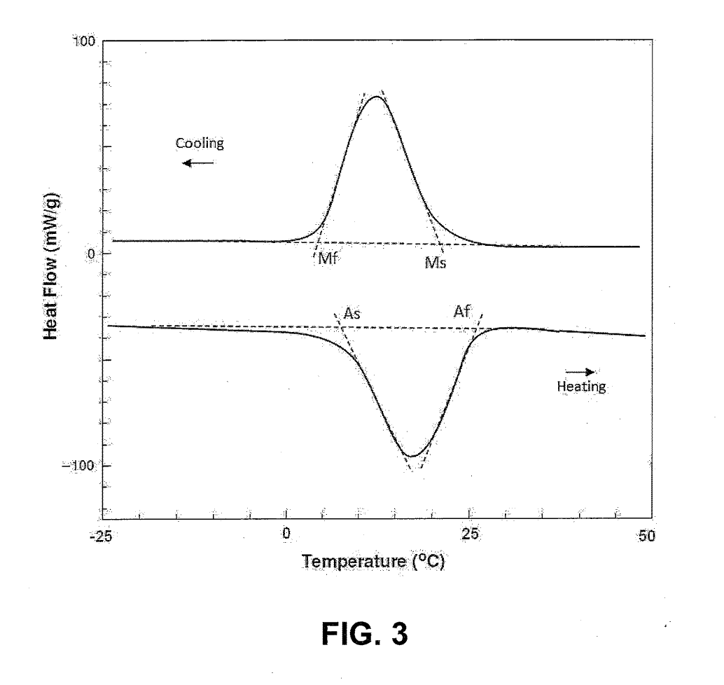

The phase transformation temperatures can be determined using Differential Scanning calorimetry (DSC) curve as shown in the FIG. 3. For example, A_{f} (austenite finish temperature) may be obtained from the graphical intersection of the baseline with the extension of the line of maximum inclination of the peak of the heating curve. The final A_{f} temperature of endodontic instrument made of shape memory alloys was measured in DSC test with general accordance with ASTM Standard F2004-05 “Standard Test Method for Transformation Temperature of Nickel-Titanium Alloys by Thermal Analysis”, such as using heating or cooling rates of 10±0.5° C./min with purge gas of either helium or nitrogen, except that the fluted segment cut from rotary instrument sample does not need any further thermal annealing process (i.e., 850° C. for 30 min in vacuum), which is typically used for measuring ingot transition temperatures at fully austenitic condition.

More particularly, FIG. 3 provides a schematic differential scanning calorimetry (DSC) curve of a shape memory alloy (nickel-titanium) in both heating and cooling cycle. A_{f} (austenite finish temperature), Aₛ (austenite start temperature), M_{f} (martensite finish temperature), Mₛ (martensite start temperature) may be obtained from the graphical intersection of the baseline with the extension of the line of maximum inclination of the appropriate peak of the curve. The martensite start temperature (Mₛ) being defined as the temperature at which the transformation from austenite to martensite begins on cooling. The martensite finish temperature (M_{f}): the temperature at which the transformation from austenite to martensite finishes on cooling; Austenite start temperature (Aₛ) being defined as the temperature at which the transformation from martensite to austenite begins on heating. The austenite finish temperature, (A_{f}) being defined as the temperature at which the transformation from martensite to austenite finishes on heating.

Experimental results have shown that the present invention (e.g., an additional heat treatment process for the formation of endodontic instruments) results in desirable characteristics. More particularly, the endodontic instruments made of NiTi shape memory alloys in their martensitic state may include one or more of the following desired characteristics for root canal surgery: (1) higher flexibility and lower stiffness; (2) improved resistance to cyclic fatigue; (3) higher degree of rotation against torsional fracture; (4) more conforming to the curved canal profile, especially for the root canals with considerable curvature and complex profile, and combinations thereof.

For example in order to compare the impact of different metallurgical structures (austenite vs. martensite), two different instrument samples were made utilizing different thermal processing in order to represent two distinct structures: (1) superelastic instruments with fully austenitic microstructure and (2) instrument with martensitic microstructure. In one specific example based on the DSC measurements, the final A_{f} temperatures for these two instruments with distinct microstructures are 17° C. (for instrument (1) having the fully austenitic microstructure) and 37° C. (for instrument (2) having the martensitic microstructure), respectively. All instrument samples were of the same geometric design. All tests were performed at ambient temperature ˜23° C.

I. Stiffness test: Showing higher flexibility and lower stiffness on endodontic instruments made of NiTi shape memory alloys in their martensitic state as compared to NiTi shape memory alloys in their austenitic state.

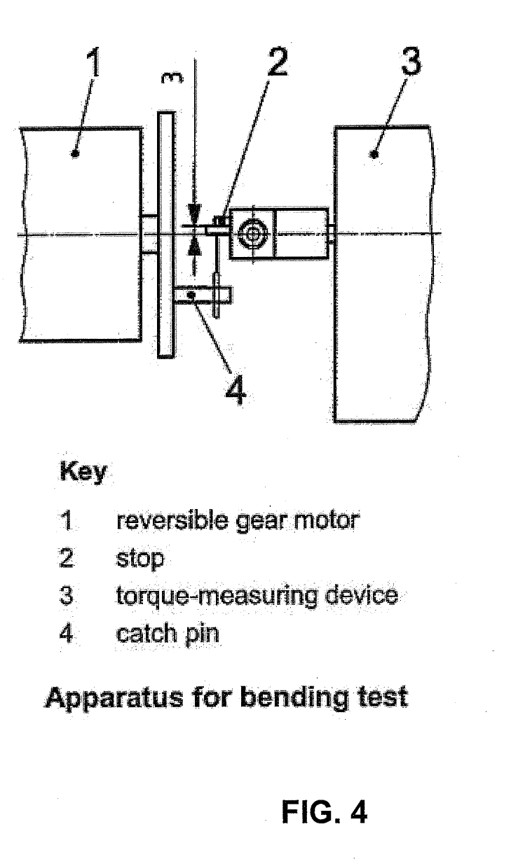

In this stiffness test, the stiffness of all sample instruments have been determined by twisting the root canal instrument through 45° using the testing apparatus as shown in FIG. 4.

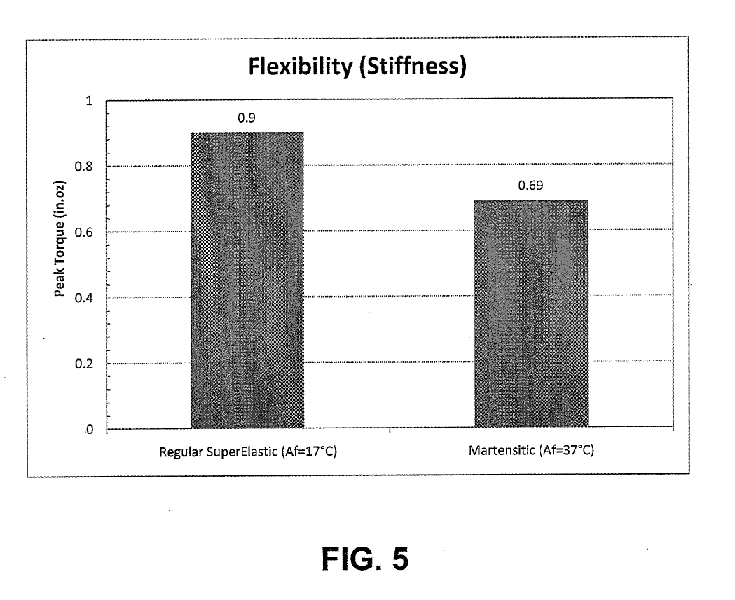

As shown in the testing results in FIG. 5, the rotary instruments with martensitic microstructure at ambient temperature exhibit higher flexibility and lower stiffness (as indicated by lower peak torque on bending). In comparison with the regular superelastic instrument with the final A_{f} temperature 17° C., the instruments with the martensitic microstructure (the final A_{f} temperature ˜37° C.) have shown 23% reduction in bending torque. The lower stiffness of martensitic instruments can be attributed to the lower Young's modulus of martensite (about 30˜40 GPa) whereas austenite is about 80˜90 GPa at ambient temperature.

FIG. 5 shows a schematic graph of the relationship between different NiTi microstructures (regular superelastic or austenic vs. martensitic) and average peak torque of endodontic rotary instruments made of NiTi shape memory alloy in bending test. As can gleemed from FIG. 5, lower peak torque (less stiff or more flexible) may be achieved by a martensitic microstructure, which is indicated by the higher A_{f} (austenite finish temperatures). In one embodiment, the ratio of peak torque (flexibility/stiffness) of the non-superelastic rotary file to the superelastic rotary file may be less than about 1:0.9 (e.g., less than about 1:0.85, and preferably less than about 1:0.8) at about 25° C.

II. Bending rotation fatigue test: Showing higher fatigue life on endodontic instruments made of NiTi shape memory alloys in their martensitic state

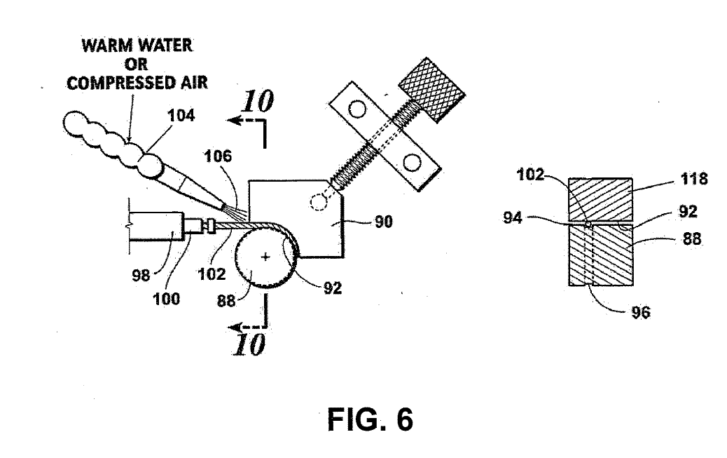

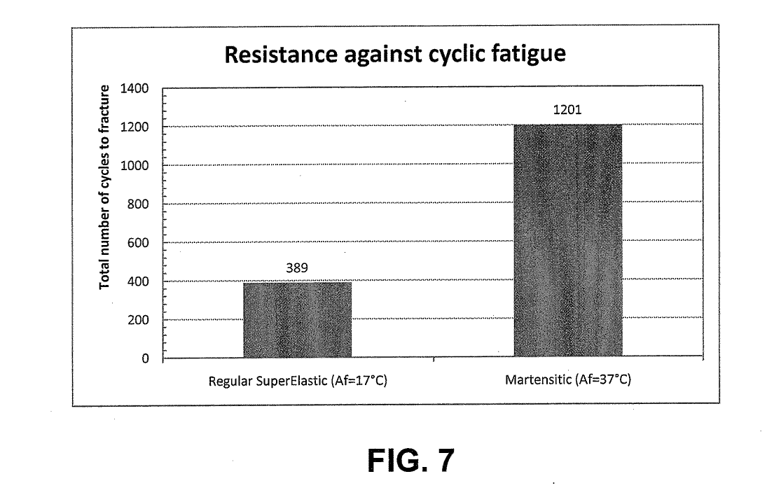

In this bending test, the fatigue resistance of all sample instruments is measured by bending rotation fatigue tester as shown in FIG. 6. According to the testing results shown in FIG. 7, the average cyclic fatigue life of instruments in the martensitic state (A.sub.f temperature 37° C.) is about 3 times of its austenitic counterpart (A_{f} temperature 17° C.).

As shown in the diagrammatic representation of FIG. 6, a test apparatus may be used to test the bending-rotation fatigue resistance of endodontic instruments. The endodontic rotary instrument sample may be generally rotating freely within a simulated stainless steel canal with controlled radius and curvature.

The schematic graph of FIG. 7 shows the relationship between different NiTi microstructures (austenic vs. martensitic) and average cyclic fatigue life of endodontic rotary instruments made of NiTi shape memory alloy. More particularly, FIG. 7 shows that longer cyclic fatigue life may be achieved by a martensitic microstructure at ambient temperature, which is indicated by the higher A_{f} (austenite finish temperature). It is appreciated that the ratio of total number of cycles to fatigue (resistance against cyclic fatigue) of the non-superelastic rotary file to the superelastic rotary file may be at least about 1.25:1 (e.g., at least about 1.5:1, preferably at least about 2:1) at about 25° C.

III. Torque test: Showing higher degree of rotation against torsional fracture on endodontic instruments made of NiTi shape memory alloys in their martensitic state

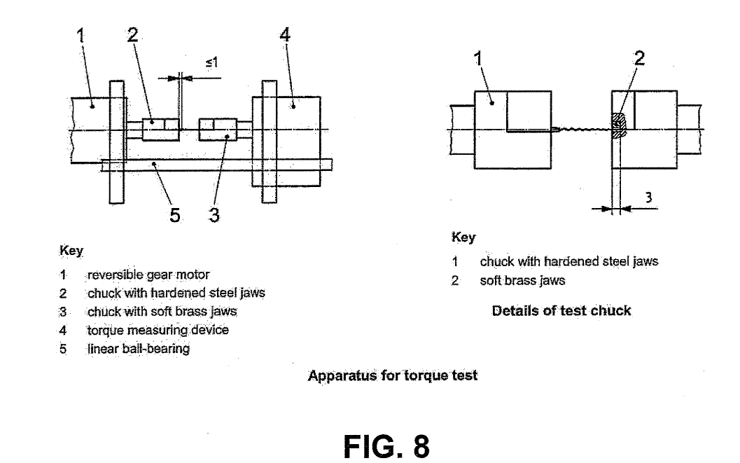

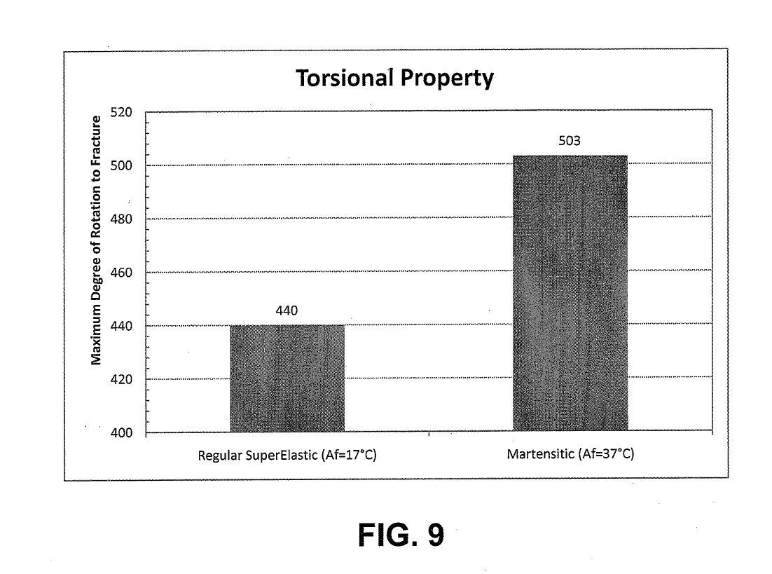

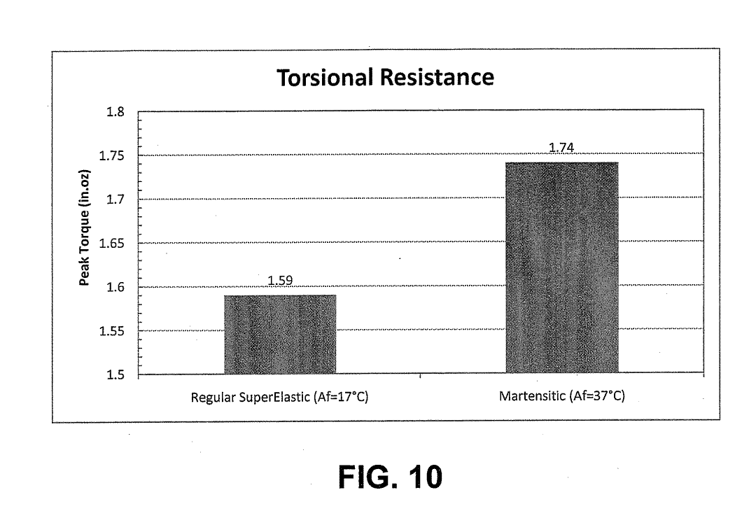

In this torque test, the resistance to fracture of root canal instruments is performed to measure the average maximum degree of rotation against torsional fracture using the testing apparatus as shown in FIG. 8. According to the testing results in FIGS. 9 and 10, the instruments with a martensitic microstructure exhibit a higher degree of rotation and peak torque against torsional fracture than their austenitic counterparts.

It is appreciated that most instrument separation may have been caused by either cyclic fatigue or torsional fracture; therefore, the separation of instruments made of shape memory alloys with martensitic microstructure may be significantly reduced according to the testing results in (II) bending rotation fatigue test and (III) torque test.

The schematic graph of FIG. 9 shows the relationship between different metallurgical structures and average “maximum degree of rotation to fracture” of endodontic rotary instruments made of NiTi shape memory alloy. More particularly, FIG. 9, shows that a higher degree of rotation may be achieved by martensitic microstructure. It is appreciated that the ratio of the maximum degree of rotation to fracture (torsional property) of the non-superelastic rotary file to the superelastic rotary file may be at least about 1.05:1 (e.g., at least about 1.075:1, preferably at least about 1.1:1) at about 25° C.

The schematic graph of FIG. 10 shows the relationship between different metallurgical structures and average “peak torque” of endodontic rotary instruments made of NiTi shape memory alloy. More particularly, FIG. 10, shows that higher torque resistance may be achieved by a martensitic microstructure. It is appreciated that the ratio of peak torque (torsional resistance) of the non-superelastic rotary file to the superelastic rotary file may be at least about 1.05:1 (e.g., at least about 1.075:1, preferably at least about 1.09:1) at about 25° C.

IV. Endodontic instruments made of NiTi shape memory alloys in their martensitic state show increased conforming to a curved canal profile

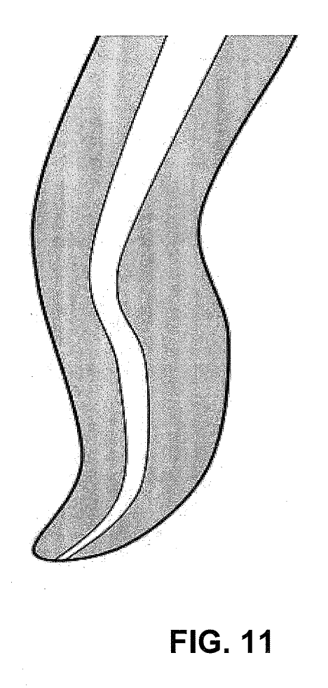

Without introducing ledging, transportation, and/or perforation, it is appreciated that instruments formed of shape memory alloys in their martensitic microstructure may be used in cleaning and shaping the highly curved canal as shown in FIG. 11. Advantageously, these instruments tend to be more conforming to the curvature of the root canal because of (1) high flexibility due to the presence of martensite; (2) better reorientation and self-accommodation capability of the martensitic variants due to the low symmetry of monoclinic crystal structure of martensite relative to the cubic crystal structure of austenite under applied dynamic stresses during root canal surgery.

Superelasticity may be generally defined as a complete rebound to the original position. However, in the industry, it is appreciated that less than 0.5% permanent set (after stretch to 6% elongation) would be acceptable. For example, if the file does not reverse to its original position, it may no longer be considered a Superelastic Shape Memory Alloy (SMA) (e.g., it may not be considered a superelastic SMA if it does not return to a generally straight position).

For NiTi based alloys in the “shape memory” form (or martensitic state), a desirable characteristic may be the temperature above which the bent materials will become straight again. For example, you may need to heat the material above its austenite finish temperature (A_{f}) to achieve a completely straight position.

It is appreciated that for shape memory alloys, once they are capable of returning to a straight position, they may be considered superelastic at this “application” temperature. However, it is further appreciated that if cooling occurs using dry ice or liquid nitrogen and the material is bent, the material may remain in the deformed position. Once the material is removed from the cold environment, the material will return to a straight form at room temperature.

It can be seen that the invention can also be described with reference to one or more of the following combinations.

A. A method for manufacturing a non-superelastic rotary file comprising the steps of: (i) providing a superelastic rotary file having an austenite finish temperature; and (ii) heating the superelastic rotary file to a temperature of at least about 300° C. for a time period of at least about 5 minutes to alter the austenite finish temperature thereby forming the non-superelastic rotary file; wherein the altered austenite finish temperature of the non-superelastic rotary file is greater than about 25° C.

B. The method of claim 1, wherein the altered austenite finish temperature of the non-superelastic rotary file is greater than 27° C.

C. The method of claim 1 or 2, wherein the altered austenite finish temperature of the non-superelastic rotary file is greater than 30° C.

D. The method of any of the preceding claims, wherein the altered austenite finish temperature of the non-superelastic rotary file is greater than 33° C.

E. The method of any of the preceding claims, wherein the altered austenite finish temperature of the non-superelastic rotary file is greater than 35° C.

F. The method of any of the preceding claims, wherein the altered austenite finish temperature of the non-superelastic rotary file is greater than 37° C.

G. The method of any of the preceding claims, wherein the heating step, the temperature ranges from about 300° C. to about 600° C.

H. The method of any of the preceding claims, wherein the heating step, the temperature ranges from about 370° C. to about 510° C.

I. The method of any of the preceding claims, wherein the heating step, the time period ranges from about 5 minutes and about 120 minutes.

J. The method of any of the preceding claims, wherein the heating step, the time period ranges from about 10 minutes and about 60 minutes.

K. The method of any of the preceding claims, wherein the superelastic rotary file includes a shape memory alloy.

L. The method of any of the preceding claims, wherein the shape memory alloy includes nickel and titanium.

M. The method of any of the preceding claims, wherein the shape memory alloy is a nickel-titanium based binary alloy.

N. The method of any of the preceding claims, wherein the shape memory alloy is a nickel-titanium based ternary alloy.

O. The method of any of the preceding claims, wherein the nickel-titanium based ternary alloy of the formula Ni—Ti—X wherein X is Co, Cr, Fe, or Nb

P. The method of any of the preceding claims, wherein the shape memory alloy includes a copper based alloy, an iron based alloy or a combination of both.

Q. The method of any of the preceding claims, wherein the shape memory alloy is the copper based alloy includes CuZnAl or CuAlNi.

R. The method of any of the preceding claims, wherein the shape memory alloy is the iron based alloy includes FeNiAl, FeNiCo, FeMnSiCrNi, or FeNiCoAITaB.

S. The method of any of the preceding claims, wherein the ratio of peak torque (flexibility/stiffness) of the non-superelastic rotary file to the superelastic rotary file is less than about 8:9 at about 25° C.

T. The method of any of the preceding claims, wherein the ratio of total number of cycles to fatigue (resistance against cyclic fatigue) of the non-superelastic rotary file to the superelastic rotary file is at least about 1.25:1 at about 25° C.

U. The method of any of the preceding claims, wherein the ratio of maximum degree of rotation to fracture (torsional property) of the non-superelastic rotary file to the superelastic rotary file is at least about 1.05:1 at about 25° C.

V. The method of any of the preceding claims, wherein the ratio of peak torque (torsional resistance) of the non-superelastic rotary file to the superelastic rotary file is at least about 1.05:1 at about 25° C.

W. The method of any of the preceding claims, further comprising the step of providing a handle and attaching the handle to a portion of the non-superelastic rotary file.

X. The method of any of the preceding claims, wherein for binary NiTi, the nickel weight percentage may range from about 45% to about 60% (e.g., about 54.5% to about 57%) with a balance of titanium composition being about 35% to about 55% (e.g., about 43% to about 45.5%).

Y. The method of any of the preceding claims, wherein for ternary NiTiX, the X element may be less than 15% (e.g., less than about 10%) in weight percentage.

Z. A method for manufacturing a non-superelastic rotary file comprising the steps of (i) providing a non-superelastic wire having an austenite finish temperature greater than about 25° C.; (ii) heating the non-superelastic wire to a manufacturing temperature that is higher that the austenite finish temperature; and (iii) forming flute(s), groove(s), or a combination of both about the superelastic wire to form a rotary file; wherein the rotary file is non-superelastic at a temperature that ranges from about 25° C. to about the austenite finish temperature.

AA. The method of claim 23, wherein the austenite finish temperature of the non-superelastic rotary file is greater than 26° C.

BB. The method of claim 23, wherein the austenite finish temperature of the non-superelastic rotary file is greater than 27° C.

CC. The method of claim 23 or 24, wherein the austenite finish temperature of the non-superelastic rotary file is greater than 30° C.

DD. The method of any of the preceding claims, wherein the austenite finish temperature of the non-superelastic rotary file is greater than 33° C.

EE. The method of any of the preceding claims, wherein the austenite finish temperature of the non-superelastic rotary file is greater than 35° C.

FF. The method of any of the preceding claims, wherein the austenite finish temperature of the non-superelastic rotary file is greater than 37° C.

GG. The method of any of the preceding claims, wherein the heating step, the manufacturing temperature ranges from about 5° C. to about 200° C.

HH. The method of any of the preceding claims, wherein the heating step, the manufacturing temperature ranges from about 10° C. to about 50° C.

II. The method of any of the preceding claims, wherein the non-superelastic wire includes a shape memory alloy.

JJ. The method of any of the preceding claims, wherein the shape memory alloy includes nickel and titanium.

KK. The method of any of the preceding claims, wherein the shape memory alloy is a nickel-titanium based binary alloy.

LL. The method of any of the preceding claims, wherein the shape memory alloy is a nickel-titanium based ternary alloy.

MM. The method of any of the preceding claims, wherein the nickel-titanium based ternary alloy of the formula Ni—Ti—X wherein X is Co, Cr, Fe, or Nb

NN. The method of any of the preceding claims, wherein the shape memory alloy includes a copper based alloy, an iron based alloy or a combination of both.

OO. The method of any of the preceding claims, wherein the shape memory alloy is the copper based alloy includes CuZnAI or CuAINi.

PP. The method of any of the preceding claims, wherein the shape memory alloy is the iron based alloy includes FeNiAI, FeNiCo, FeMnSiCrNi or FeNiCoAITaB.

QQ. The method of any of the preceding claims, further comprising the step of providing a handle and attaching the handle to a portion of the non-superelastic rotary file.

RR. The method of any of the preceding claims, wherein the handle is located distally from the flute(s), groove(s), or any combination thereof.

SS. A method for manufacturing a non-superelastic rotary file comprising the steps of providing a superelastic rotary file having an austenite finish temperature; and heating the superelastic rotary file to a temperature of at least about 300° C. for a time period of at least about 5 minutes to alter the austenite finish temperature thereby forming the non-superelastic rotary file; wherein the altered austenite finish temperature of the non-superelastic rotary file is greater than about 25° C.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed:

1. A method for manufacturing a non-superelastic rotary file comprising the steps of:
providing a superelastic rotary file having an austenite finish temperature; and
heating the superelastic rotary file to a temperature of at least about 300° C. for a time period of at least about 5 minutes to alter the austenite finish temperature thereby forming the non-superelastic rotary file;
wherein the altered austenite finish temperature of the non-superelastic rotary file is greater than about 25° C.

2. The method of claim 1, wherein the altered austenite finish temperature of the non-superelastic rotary file is greater than 30° C.

3. The method of claim 2, wherein the altered austenite finish temperature of the non-superelastic rotary file is greater than 37° C.

4. The method of claim 1, wherein the heating step, the temperature ranges from about 300° C. to about 600° C.

5. The method of claim 4, wherein the heating step, the time period ranges from about 5 minutes and about 120 minutes.

6. The method of claim 1, wherein the superelastic rotary file includes a shape memory alloy.

7. The method of claim 6, wherein the shape memory alloy includes nickel and titanium.

8. The method of claim 6, wherein the shape memory alloy includes a copper based alloy, an iron based alloy or a combination of both.

9. The method of claim 1, wherein a ratio of peak torque of the non-superelastic rotary file to the superelastic rotary file is less than about 8:9 at about 25° C.

10. The method of any of the preceding claims, wherein a ratio of total number of cycles to fatigue of the non-superelastic rotary file to the superelastic rotary file is at least about 1.25:1 at about 25° C.

11. The method of claim 1, wherein:
(i) the altered austenite finish temperature of the non-superelastic rotary file is greater than 30° C.;
(ii) the heating step, the temperature ranges from about 300° C. to about 600° C.;
(iii) the heating step, the time period ranges from about 5 minutes and about 120 minutes;
(iv) the superelastic rotary file includes a shape memory alloy, the shape memory alloy includes nickel and titanium.

12. A method for manufacturing a non-superelastic rotary file comprising the steps of:
providing a non-superelastic wire having an austenite finish temperature greater than about 25° C.;
heating the non-superelastic wire to a manufacturing temperature that is higher that the austenite finish temperature; and
forming flutes, grooves, or a combination of both about the superelastic wire to form a rotary file;
wherein the rotary file is non-superelastic at a temperature that ranges from about 25° C. to about the austenite finish temperature.

13. The method of claim 12, wherein the austenite finish temperature of the non-superelastic rotary file is greater than 27° C.

14. The method of claim 12, wherein the austenite finish temperature of the non-superelastic rotary file is greater than 37° C.

15. The method of claim 12, wherein the heating step, the manufacturing temperature ranges from about 5° C. to about 200° C.

16. The method of claim 12, wherein the non-superelastic wire includes a shape memory alloy.

17. The method of claim 16, wherein the shape memory alloy includes nickel and titanium.

18. The method of claim 16, wherein the shape memory alloy is a nickel-titanium based ternary alloy.

19. The method of any of claim 18, wherein the nickel-titanium based ternary alloy of the formula Ni—Ti—X wherein X is Co, Cr, Fe, or Nb.

20. The method of claim 1, wherein:
the altered austenite finish temperature of the non-superelastic rotary file is greater than 30° C.;
(ii) the heating step, the temperature ranges from about 300° C. to about 600° C.;
(iii) the superelastic rotary file includes a shape memory alloy, the shape memory alloy includes nickel and titanium; and
(iv) a ratio of peak torque of the non-superelastic rotary file to the superelastic rotary file is less than about 8:9 at about 25° C.
